(19) United States
(12) Patent Application Publication
(10) Pub. No.: US 2013/0085818 A1
(43) Pub. Date: Apr. 4, 2013

(54) METHOD OF MANAGING A DRIVER REWARDS PROGRAMME AND A SYSTEM THEREFOR

(71) Applicants: Adrian Gore, Sandton (ZA); Alan Pollard, Sandton (ZA)

(72) Inventors: Adrian Gore, Sandton (ZA); Alan Pollard, Sandton (ZA)

(73) Assignee: DISCOVERY HOLDINGS LIMITED, Sandton (ZA)

(21) Appl. No.: 13/641,143

(22) PCT Filed: Apr. 13, 2011
(86) PCT No.: PCT/IB11/51604

§ 371 Date: Dec. 14, 2012

(30) Foreign Application Priority Data
Apr. 14, 2010 (ZA) 2010/02598
Jul. 28, 2010 (ZA) 2010/05379
Aug. 3, 2010 (ZA) 2010/05533
Feb. 16, 2011 (ZA) 2011/01241

(51) Int. Cl. G06Q 30/02; G06Q 10/06

(52) U.S. Cl. CPC G06Q 30/0207
USPC 705/14.1

(57) ABSTRACT

A method of managing a driver rewards programme includes receiving data including information relating to the compliance of a driver in one or more of a plurality of programme areas related to motor vehicle driver behaviour and storing the data in a database. Awarding points to the driver wherein the points allocated are related to the compliance of the driver in one or more of the programme areas and using the points allocated to determine a reward for the driver.

### BACKGROUND OF THE INVENTION

The present invention relates to a method of managing a driver rewards programme and a system therefor.

Drivers of motor vehicles are not motivated in any meaningful way to improve their driver behaviours thereby aiming toward safer driving.

The present invention seeks to address this.

### SUMMARY

According to one example embodiment there is provided a method of managing a driver rewards programme, the method including:
receiving data including information relating to the compliance of a driver in a plurality of programme areas related to motor vehicle driver behaviours and storing the data in a database;
awarding points to the driver wherein the points allocated are related to the compliance of the driver in the programme areas; and
using the points allocated to determine a reward for the driver.

The points allocated may be used to award a driver status, wherein the driver status is used to determine a reward for the driver.

The plurality of programme areas may include at least some of vehicle maintenance, driver education, vehicle insurance claims and driving performance.

The plurality of programme areas may include all of vehicle maintenance, driver education, vehicle insurance claims and driving performance.

The programme area of vehicle maintenance includes one or more of servicing the vehicle, checking the vehicle and checking the vehicles tyres.

The programme area of driver education includes one or more of a driving course, a driver assessment, a periodic driver quiz and a carbon footprint calculation.

The programme area of vehicle insurance claims includes the number of claim free years.

The programme area of driving score includes monitoring the manner in which the motor vehicle is driven.

According to another example embodiment there is provided a system for managing a driver rewards programme, the system including:
a receiving module for receiving data relating to the compliance of a driver in a plurality of programme areas related to motor vehicle driver behaviours;
a calculation module to award points to the driver wherein the points allocated are related to the compliance of the driver in the programme areas; and
a rewards module to use the points allocated to determine a reward for the driver.

The calculation module may use the points allocated to determine a driver status, wherein the driver status is used to determine the reward for the driver.

In one example, the plurality of programme areas includes at least some of vehicle maintenance, driver education, vehicle insurance claims and driving performance.

In another example, the plurality of programme areas includes all of vehicle maintenance, driver education, vehicle insurance claims and driving performance.

The programme area of vehicle maintenance may include one or more of servicing the vehicle, checking the vehicle and checking the vehicles tyres.

Te programme area of driver education may include one or more of a driving course, a driver assessment, a periodic driver quiz and a carbon footprint calculation.

The programme area of vehicle insurance claims may include the number of claim free years.

The programme area of driving score may include monitoring the manner in which the motor vehicle is driven.

Furthermore, the system may further include:
the receiving module obtains driver data from a device associated with a motor vehicle; and
the analysing module analyses the data to determine the manner in which the motor vehicle has been driven for a past period.

### BRIEF DESCRIPTION OF THE DRAWINGS

FIG. 1 is a block diagram illustrating an example system to implement the methodologies described herein;

FIG. 2 illustrates an example system environment in which the embodiment is implemented; and

FIG. 3 is a block diagram illustrating an example embodiment method.

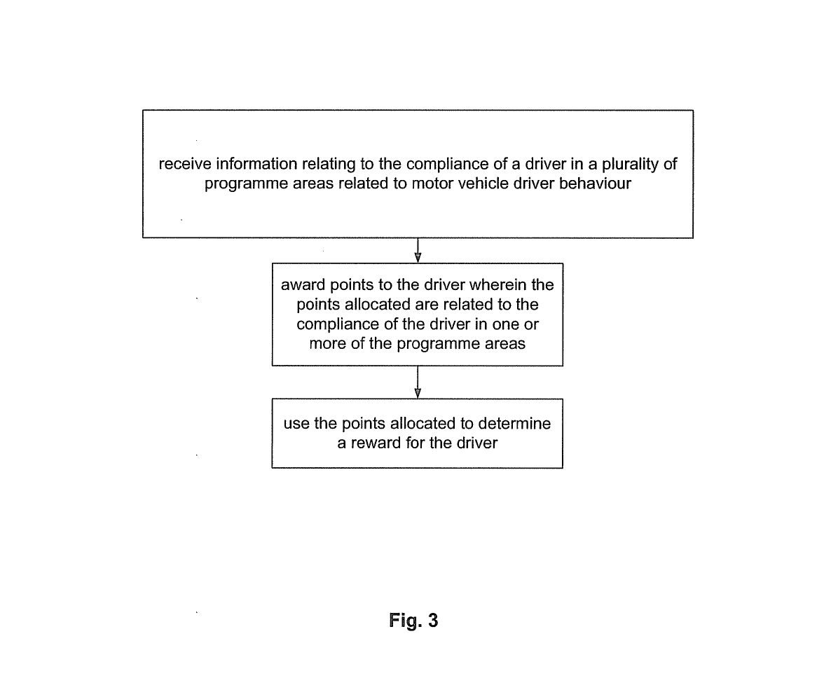

### DESCRIPTION OF EMBODIMENTS

The present invention relates to a method of managing a driver rewards programme and a system therefor.

It will be appreciated that the rewards programme could be run by an insurer that insures motor vehicles. Alternatively, the programme could be run by a third party.

Various insurance schemes are known to insure motor vehicles in the event of an accident or against theft, for example.

These insurance schemes typically have the owner of the motor vehicle as the insured person. The insured person pays a premium to the insurer to insure the motor vehicle against an insured event such as an accident or against theft, for example.

The quantum of the premium is usually determined using a number of factors such as the value of the motor vehicle and in certain cases the driver's age.

The above factors are also used to determine an excess which is a first amount paid by the insured person in the event of a claim before the insurer pays towards the claim.

However, these insurance schemes do not take into account driver behaviour nor vehicle mechanical condition in any meaningful way.

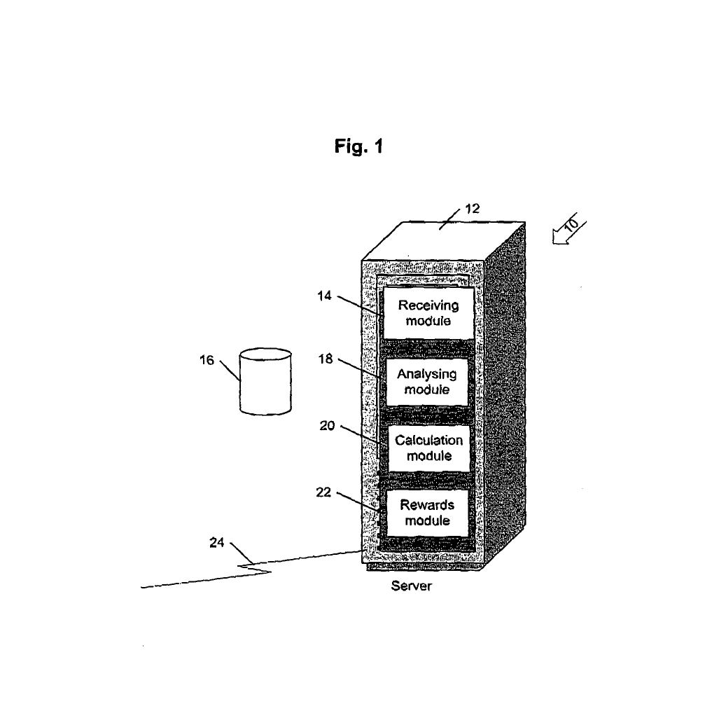

Referring to FIG. 1, an information processing system 10 may include a server 12 that includes a number of modules to implement the present invention.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 12 includes a receiving module 14 to receive the data and to write the data to a memory 16.

The memory 16 is typically in the form of a database associated with the server 12.

The receiving module 14 receives compliance data containing information relating to the compliance of a driver in a plurality of programme areas related to motor vehicle driver behaviour.

The compliance data is stored in the database 16.

An analysing module 18 analyses the compliance data to determine driver behaviour. This will be described in more detail below.

A calculation module 20 awards points to the driver wherein the points allocated are related to the compliance of the driver in one or more of the programme areas. An example of this is described below.

Finally, the points allocated are used by a rewards module 22 to determine a reward for the driver.

The plurality of programme areas includes at least some of vehicle maintenance, driver education, vehicle insurance claims, premium payments, policy updates and driving performance.

In one example embodiment, the plurality of programme areas includes all of the abovementioned programme areas.

The programme area of vehicle maintenance includes one or more of servicing the vehicle, checking the vehicle and checking the vehicles tyres.

Describing these programme areas in more detail, servicing the vehicle means that the driver has taken the vehicle to a mechanical workshop for a periodic service to ensure that the vehicle is in good working order. Typically in such services oil and other lubricants are changed, brake pads are changed if required and any other mechanical faults that have arisen in the past period are fixed.

The programme area of checking the vehicle entails taking the vehicle to an authorised centre were a number of checks on the different parts of the vehicle are conducted to ensure that the vehicle is in good working order. If anything is found to be not correct, the driver will be instructed to take the vehicle to a workshop for fixing and may be awarded further points for this step.

New vehicles may be exempt from the service check for the first year and the insured person will be awarded these points on submission of proof that the vehicle is within its first year since its first registration.

Checking the vehicle tyres entails either having the tyres checked as part of the above-mentioned checking of the vehicle or alternatively, taking the vehicle to a specialist tyre centre to have the tyres checked.

In one example embodiment, an interface is created between the server 12 and checking centre via the communications network 24 so that the checking centre can confirm the results of the check.

In addition to the tyre check the steering, windscreen wipers, lights, seatbelts, hooter and shock absorbers can be checked at this time.

Bonus Points can be awarded for all of these being in an acceptable condition.

In all of these cases, the party doing the checking or servicing will capture data relating to the vehicle and/or driver and periodically transmit this data to the receiving module 14.

The programme area of driver education includes one or more of a driving course, a driver assessment, a periodic driver quiz and a carbon footprint calculation.

Driving courses are attended by drivers to improve their driving skills and particularly to learn so-called defensive driving skills.

A driver assessment is conducted in one example embodiment by an assessor taking the driver in the vehicle onto the road and assessing the driving skills and habits of the driver.

Weaknesses in the skills or habits of the driver may be pointed out and the driver given the opportunity to correct these in the coming weeks or months before returning for an updated assessment.

In one example, the driver is given an assessment score.

In another example, the driver assessment is an online questionnaire designed to highlight certain risks relating to a driver.

In this example, the questionnaire includes two sections namely. ‘Driving habits’ and ‘State of Vehicle’. For example a question of whether one uses a cellular telephone to send messages while driving will be asked. At the end of the questionnaire (approximately 20 questions) the driver will receive feedback explaining their risk and suggesting ways to mitigate their risks.

Based on the answers received a calculation will be performed to consider the driver's risk relative to an average driver. The results can be illustrated to the driver on two risk bars. One illustrates how risky the driver's habits are, and one illustrates risks relating to the state of the drivers vehicle.

A third risk bar may also be included illustrating a combined risk score.

In addition, the questionnaire may include educational information to address specific areas such as how to drive in wet weather or what to do in the event of an accident. The format will be a paragraph followed by a question relating to the paragraph

In this example, the driver will typically use a user interface device in the form of a computer with a screen on which is displayed a template for the driver to capture answers to questions put to them.

The answers are captured and transmitted to the server 12.

Alternatively, the server 12 accesses driver information stored in the database 16 and obtains the driver's e-mail address.

An e-mail is then sent to the retrieved e-mail address. When the driver opens the e-mail a template is displayed to them asking them the relevant questions with options to select various scores.

A driver will send the e-mail back to the server 12 via a communications network and the receiving module 16. These will be received and written to the database.

The programme area of premium payments relates to the quantum and frequency with which the premium payments are made and if they are made on time or not and the programme area of policy updates relates to whether or not the insured person is updating their policy to accurately reflect what is being insured by the insured person.

The programme area of vehicle insurance claims includes the number of claim free years. No fault claims where the driver was not at fault typically will not be calculated as a claim for this.

The programme area of driving score includes monitoring the manner in which the motor vehicle is driven.

In one example embodiment this is implemented using data received from a telematics device 26 associated with the vehicle 28 which is the vehicle that is insured on the insurance policy. It will be appreciated that in one example the telemetry device 12 will be installed in the motor vehicle either at the time of production or retro-fitted.

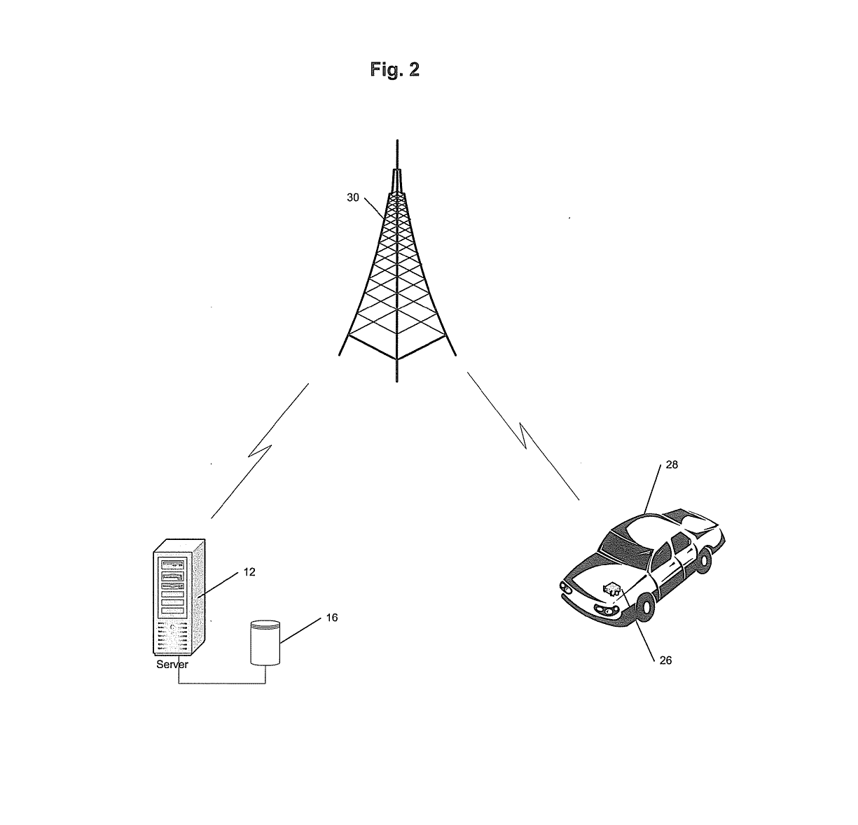

In any event, referring to FIG. 2, a motor vehicle 28 is fitted with the telemetry device 26.

The telemetry device 26 is used to monitor a number of aspects of the use of the motor vehicle.

For example, the device monitors the speed at which the vehicle is travelling and can therefore calculate average speed and maximum and minimum speeds, for example.

Where the device includes GPS functionality, for example, the device is able to determine if speed limits on a particular road have been exceeded.

The device is also able to determine braking habits of the driver either using the GPS functionality or by using an accelerometer or having one or more sensors connected to the vehicle or to a deceleration detection device, for example.

The device is also typically able to detect the distance travelled and if the driver has driven the vehicle for a long time period without a break.

In addition, the times of the day that the vehicle is being driven can be captured as night time driving is statistically more dangerous than day time driving, especially weekend late night driving.

In addition to the above, the device will have the ability to detect the driver's use of the vehicle including braking, indicating, cornering and accelerating to name a few examples. Thus it could be determined when the vehicle turns without indicating, for example.

In any event, the data from the device is transmitted to the server 12 over a communication network 30.

It will be appreciated that this could be accomplished in a number of ways. For example, the data could be transmitted via a communication network 30 as illustrated in the accompanying drawing. This communication network could be any suitable kind of communication network such as a mobile communication network, a wireless communication network, a satellite communication network or a combination of these to name but a few examples.

Alternatively, the device 26 could be connected to another intermediate device which downloads the data and transmits the data via the communication network 30 to the server 12. One example of this could be connecting the device 26 to a USB port of a computer and downloading the data to the computer, which data is then transmitted over the Internet to the server 12.

In one example embodiment, the data is transmitted over a mobile phone network using the short message service (SMS) protocol.

It will be appreciated that the data could be transmitted at any suitable time to the server. For example, the data could be transmitted in real time or near real time or could be transmitted periodically such as daily, weekly or monthly to name a few examples.

Once the server 12 receives the data it will analyse the data to determine the manner in which the motor vehicle has been driven for a past predetermined period.

To do this the analysing module 18 accesses the memory 16 and retrieves the data stored therein.

The retrieved data is then used to determine a driving score. For example, the driver starts on a higher number of points which is reduced for each driving infraction, such as each harsh braking, speeding or late night driving instance as can be predetermined by the system managers.

An example of how the calculation module 20 then awards points is as follows:

| | Driver Category | Points | Frequency |
|---|---|---|---|
| Driving | No Star (no telematics device) | | Monthly |
| score | * | — | |
| | ** | 100 | |
| | *** | 350 | |
| | **** | 800 | |
| Road | Annual Service | 50 | Annual |
| worthy | Multi Point Check | 50 | |
| | Multi point check bonus points | 100 | |
| Education | Defensive driving course | 150 | Every 3 years |
| | Driver Assessment | 50 | Annual |
| | Quarterly quiz | 75 | ¼ly |
| | Carbon footprint calculated | 50 | Monthly |
| Claim | 1 | 25 | Monthly |
| Free | 2 | 50 | |
| Years | 3+ | 100 | |

It will be appreciated that the actual number of points allocated may change and other categories may be introduced.

In one example embodiment the number of points is used to determine a driver status. An example driver status is as follows:

Driver Status

| | |
|---|---|
| Red | 0 |
| Amber | 300 |
| Green | 600 |
| Double Green | 1000 |

It will be appreciated that the way in which the points are allocated and driver status determined could be varied. However, in an example embodiment the status will be determined periodically, for example every month.

At the beginning of every calendar month the driver's points are zeroed and drivers will then be awarded points for having done a multi point check, annual service, driver assessment or carbon footprint calculation within the previous 12 months.

Similarly quarterly quiz points will be awarded provided the questionnaire has been done for that quarter.

Defensive driving courses need to be completed every 3 years or any other specified period to earn points and if a defensive driving course has been completed in the past 3 years then the relevant points will be added to the driver score for the present month.

If confirmation of these point earning events are received midmonth then points will be awarded immediately therefore contributing to the driver status in that month.

On the last day of each month the driver's telematic data or a telematic score will be received and points award points accordingly.

If multiple vehicles are insured then one method of dealing with this is to use a weighted average to calculate a single score calculated.

This will complete the driver's points for the month which will be added together to get the driver status for that month.

The driver status and individual driver telematic scores are communicated to the principle drivers via the communication network 24 as well as the policy holder where the policy holder is different to the driver.

In addition, reminders are sent out when a roadworthy check or tyre check is required via the communication network 24.

At periodic intervals rewards are awarded to the driver. This motivates the driver to improve their driver behaviours.

In one example, the rewards in a given month will be based on the greater of the status achieved in the previous month (or amber at duration month 1) and the status at the date of discount calculation.

In one example, a retail reward may be implemented.

One example of implementing a retail reward is that each driver will be eligible to apply for a credit card from a company associated with the rewards company.

This will entitle them to retail partner cash backs for spending at retail partners associated with the credit card company.

Another example would be to use a non-transactional card to capture retail spend and then refund the driver based on the retail spend captured by transferring funds into a bank account of the driver.

The cash back % in a given month will be based on the higher of the Driver Status from the previous month and the Driver Status on the discount calculation date.

An example of retail partner discounts is as follows:

| Status | Cash Back |
|---|---|
| Red | 0% |
| Amber | 5% |
| Green | 7.5% |
| D Green | 15% |

Another example of a reward is a travel related reward. This could take the form of a discount on flights and/or car hire as follows:

| Status | Discount |
|---|---|
| Red | 0% |
| Amber | 5% |
| Green | 7.5% |
| D Green | 15% |

In addition, discounts on hotel bookings could also be available as follows:

| Status | Discount |
|---|---|
| Red | 0% |
| Amber | 5% |
| Green | 7.5% |
| D Green | 15% |

Once the correct reward has been determined, the rewards module 22 then effects the reward. In one example embodiment this could be done by communicating with a financial institution via the communications network 24 and instructing the financial institution to implement the reward.

Typically the financial institution will be instructed to pay an amount of funds to the driver.

It should be appreciated that all of the above are non-limiting examples of rewards and discount amounts related to these rewards.

Thus it will be appreciated that the present invention provides a method of rewarding the driver thereby motivating them to improve their driver behaviours including their driving skills and to look after their motor vehicle. This helps ensure the driver's safety while at the same time results in reduced claims to the insurer and is therefore beneficial to all parties.

1-18. (canceled)

19. A method of managing a driver rewards programme, the method including:
receiving, by a computer, data including information relating to compliance of a driver in a plurality of programme areas related to motor vehicle driver behaviours and storing, in the computer, the data in a database;
awarding points to the driver wherein the points allocated are calculated by the computer and are related to the compliance of the driver in the programme areas; and
using the points allocated to determine a reward for the driver.

20. A method according to claim 19 wherein the points allocated are used to determine a driver status, wherein the driver status is used to determine the reward for the driver.

21. A method according to claim 19 wherein the plurality of programme areas include at least some of vehicle maintenance, driver education, vehicle insurance claims and driving performance.

22. A method according to claim 19 wherein the plurality of programme areas include all of vehicle maintenance, driver education, vehicle insurance claims and driving performance.

23. A method according to claim 21 wherein the programme area of vehicle maintenance includes one or more of servicing the vehicle, checking the vehicle and checking the vehicles tires.

24. A method according to claim 21 wherein the programme area of driver education includes one or more of a driving course, a driver assessment, a periodic driver quiz and a carbon footprint calculation.

25. A method according to claim 21 wherein the programme area of vehicle insurance claims includes the number of claim free years.

26. A method according to claim 21 wherein the programme area of driving performance includes monitoring the manner in which a motor vehicle is driven.

27. A method according to claim 26 wherein monitoring the manner in which the motor vehicle is driven includes:
obtaining data from a device associated with a motor vehicle; and
analysing the data with the computer to determine the manner in which the motor vehicle has been driven for a past period.

28. A computer system for managing a driver rewards programme, the computer system including:
a receiving module for receiving data relating to compliance of a driver in a plurality of programme areas related to motor vehicle driver behaviours;
a calculation module to award points to the driver wherein the points allocated are related to the compliance of the driver in the programme areas; and
a rewards module to use the points allocated to determine a reward for the driver.

29. A computer system according to claim 28 wherein the calculation module uses the points allocated to determine a driver status, wherein the driver status is used to determine the reward for the driver.

30. A computer system according to claim 28 wherein the plurality of programme areas include at least some of vehicle maintenance, driver education, vehicle insurance claims and driving performance.

31. A computer system according to claim 28 wherein the plurality of programme areas include all of vehicle maintenance, driver education, vehicle insurance claims and driving performance.

32. A computer system according to claim 28 wherein the programme area of vehicle maintenance includes one or more of servicing the vehicle, checking the vehicle and checking the vehicles tires.

33. A computer system according to claim 28 wherein the programme area of driver education includes one or more of a driving course, a driver assessment, a periodic driver quiz and a carbon footprint calculation.

34. A computer system according to claims 30 wherein the programme area of vehicle insurance claims includes the number of claim free years.

35. A computer system according claim 30 wherein the programme area of driving score includes monitoring the manner in which the motor vehicle is driven.

36. A computer system according claim 28 further wherein:
the receiving module obtains driver data from a device associated with a motor vehicle; and
the analysing module analyses the data to determine the manner in which the motor vehicle has been driven for a past period.
